(19) United States
(12) Patent Application Publication
(10) Pub. No.: US 2014/0300936 A1
(43) Pub. Date: Oct. 9, 2014

(54) SCANNING MODULE STRUCTURE

(71) Applicant: Primax Electronics Ltd., Taipei (TW)

(72) Inventors: Chao-Min Yang, Neihu, Taipei (TW); Wen-An Huang, Neihu, Taipei (TW)

(73) Assignee: Primax Electronics Ltd., Taipei (TW)

(21) Appl. No.: 13/958,790

(22) Filed: Aug. 5, 2013

(30) Foreign Application Priority Data
Apr. 3, 2013 (CN) 201320165667.8

(51) Int. Cl. H04N 1/028

(52) U.S. Cl. CPC H04N 1/02895
USPC 358/475

(57) ABSTRACT

A scanning module structure includes an optical reflective casing, a light-emitting element, and an optical sensing module. The optical reflective casing includes plural fixed tilting structures and plural reflective aluminum sheets. The plural fixed tilting structures are integrally formed with the optical reflective casing. The plural reflective aluminum sheets are disposed on corresponding fixed tilting structures. The light-emitting element is used for emitting a light beam. The light beam is reflected by the plural reflective aluminum sheets. When the scanning module structure is enabled, the light beam emitted by the light-emitting element is projected onto a document. After the light beam is reflected by the document, the light beam is introduced into the optical sensing module. The light beam is sequentially reflected by the plural reflective aluminum sheets, and then projected onto the optical sensing module. Consequently, a document image corresponding to the document is generated.

### FIELD OF THE INVENTION

The present invention relates to a scanning apparatus, and more particularly to a scanning module structure of a scanning apparatus.

### BACKGROUND OF THE INVENTION

With increasing development of scientific technologies, the people's customs are gradually changed. For example, as the science and technology advance, the method of storing documents is changed from the filing of paper documents to the storage of the electronic files of the documents. Generally, a scanning apparatus is a device for creating the electronic files of the documents. By the scanning apparatus, the contents of the paper documents are converted into electronic files. The electronic files can be further spread, managed or stored by the user.

A flatbed scanner is one of the early scanning apparatuses. The flatbed scanner comprises a scanning platform and a scanning module structure. The scanning module structure is disposed under the scanning platform. The scanning platform is used for placing a single document thereon. The scanning module structure is movable under the scanning platform. As the scanning module structure is moved, the single document is scanned by the scanning module structure. That is, the conventional flatbed scanner is capable of scanning a single document at a time. When the user wants to use the conventional flatbed scanner to scan the images of plural documents, the document on the scanning platform should be manually and repeatedly replaced with a new one. Consequently, the plural documents can be scanned by the conventional flatbed scanner Since the process of manually replacing the documents is very troublesome, the conventional flatbed scanner is not feasible to scan plural documents. For solving these drawbacks, an automatic document feeder is introduced into the market. The automatic document feeder and the flatbed scanner are collaboratively defined as a sheet-feeding type scanning apparatus. By the sheet-feeding type scanning apparatus, plural documents can be automatically fed and scanned without the need of manually replacing the documents.

Hereinafter, the configurations of a conventional sheet-feeding type scanning apparatus will be illustrated with reference to FIG. 1. FIG. 1 is a schematic view illustrating a conventional sheet-feeding type scanning apparatus. The conventional sheet-feeding type scanning apparatus 1 comprises an automatic document feeder 10 and a flatbed scanner 11. The automatic document feeder 10 comprises a document input tray 101, a document discharge tray 102, a document pick-up module 103, a conveying channel 104, plural conveying rollers 105, and a document discharge roller assembly 106. The flatbed scanner 11 comprises a scanning module structure 111, a scanning platform 112, and a scanning region 113. Both of the scanning platform 112 and the scanning region 113 are made of a transparent material. The functions of the scanning module structure 111 and the scanning platform 112 are identical to those that are illustrated above, and are not redundantly described herein.

A process of scanning plural documents S by the conventional sheet-feeding type scanning apparatus 1 will be illustrated in more details as follows. Firstly, the document pick-up module 103 is swung to be contacted with the plural documents S on the document input tray 101, and the uppermost document S of the plural documents S is fed into the conveying channel 104 by the document pick-up module 103. Then, the document S is transported by the plural conveying rollers 105 and moved across the region over the scanning module structure 111. When the document S is moved across the region over the scanning module structure 111, a light beam B (see FIG. 2) is emitted by the scanning module structure 111. The light beam B is transmitted through the scanning region 113 and projected onto the document S. Consequently, the document S is scanned by the scanning module structure 111, and a document image corresponding to the document S is acquired. After the document S is scanned, the document S is ejected to the document discharge tray 102 by the plural conveying rollers 105 and the document discharge roller assembly 106. Meanwhile, the process of scanning the document S is completed. The processes of scanning the remaining documents S on the document input tray 101 are similar to the above process, and are not redundantly described herein.

Hereinafter, the configurations and operations of the scanning module structure 111 will be illustrated with reference to FIGS. 1 and 2. FIG. 2 is a schematic cross-sectional view illustrating a conventional scanning module structure. The conventional scanning module structure 111 comprises a casing 1111, a light-emitting element 1112, plural reflective mirrors 1113, plural fixing elements 1114, and an optical sensing module 1115. The casing 1111 has an opening 1116. The opening 1116 is formed in a top surface of the casing 1111. The light-emitting element 1112 is located at a side of the opening 1116 for emitting the light beam B and projecting the light beam B onto the document S. The plural reflective mirrors 1113 are disposed within the casing 1111 for reflecting the light beam B. The plural fixing elements 1114 correspond to the plural reflective mirrors 1113. In addition, the plural fixing elements 1114 are disposed on the casing 1111. The plural fixing elements 1114 are connected with the plural reflective mirrors 1113 for fixing the plural reflective mirrors 1113 on the casing 1111. The light-emitting element 1112 is a lamp tube. The plural reflective mirrors 1113 are all made of a silver metal material. The plural fixing elements 1114 are resilient metal sheets.

The optical sensing module 1115 is partially disposed within the casing 1111, and arranged along an optical path of the light beam B. The optical sensing module 1115 is used for receiving the light beam B and generating the document image corresponding to the document S. The optical sensing module 1115 comprises a focusing lens 1117, an optical sensing element 1118, and a circuit board 1119. The focusing lens 1117 is disposed within the casing 1111, and arranged along the optical path of the light beam B. After the light beam B is reflected by the plural reflective mirrors 1113, the light beam B is focused by the focusing lens 1117. The optical sensing element 1118 is located near the focusing lens 1117 and disposed on the circuit board 1119 for receiving the focused light beam B and thereby generates the document image. The circuit board 1119 is connected with the casing 1111 for supporting the optical sensing element 1118 and outputting the document image. For example, the optical sensing element 1118 is a charge couple device (CCD) or a contact image sensor (CIS).

During the plural documents S are scanned by the conventional sheet-feeding type scanning apparatus 1, the scanning module structure 111 is enabled, and the light beam B from the light-emitting element 1112 is projected on the document S. The light beam B is reflected by the document S and introduced into the casing 1111 through the opening 1116. The light beam B is sequentially reflected by the plural reflective mirrors 1113 many times, and then directed to the focusing lens 1117. After the light beam B is focused by the focusing lens 1117, the focused light beam B is received by the optical sensing element 1118, and thus a partial document image is generated by the optical sensing element 1118. The partial document image corresponds to the portion of the document S that is irradiated by the light beam B. Then, as the document S is continuously transported, the above operations of the scanning module structure 111 are performed to acquire plural partial document images. The plural partial document images are outputted from the circuit board 1119 to a processing unit (not shown), which is connected with the circuit board 1119. After the plural partial document images are combined by the processing unit, the document image corresponding to the document S is generated.

However, the conventional scanning module structure 111 still has some drawbacks. For example, the plural reflective mirrors 1113 are fixed in the casing 111 by the plural fixing elements 1114. For allowing the light beam B to be correctly reflected by the plural reflective mirrors 1113 and allowing the light beam B to be directed to the optical sensing element 1118, the installation angles of the plural fixing elements 1114 should be precisely controlled. That is, the plural reflective mirrors 1113 and the plural fixing elements 1114 should be precisely assembled. If the plural reflective mirrors 1113 and the plural fixing elements 1114 are not precisely assembled, the image quality is largely impaired. Moreover, the assembling cost is very high. After the scanning module structure 111 has been used for a long time, the fixing elements 1114 may be suffered from deformation or abrasion. Under this circumstance, the installation angles of the plural reflective mirrors 1113 are also adversely affected, and the scanning quality is deteriorated.

Therefore, there is a need of providing a scanning module structure with reduced assembling cost.

### SUMMARY OF THE INVENTION

The present invention provides a scanning module structure with reduced assembling cost.

The present invention also provides a scanning module structure with stable scanning quality.

The present invention further provides a scanning module structure with reduced weight.

In accordance with an aspect of the present invention, there is provided a scanning module structure of a scanning apparatus for scanning a document. The scanning module structure includes a light-emitting element, an optical reflective casing, and an optical sensing module. The light-emitting element is used for emitting a light beam and projecting the light beam onto the document. The light-emitting element is disposed on the optical reflective casing. The optical reflective casing comprises plural fixed tilting structures and plural reflective aluminum sheets. The plural fixed tilting structures are extended from an inner surface of the optical reflective casing. The plural reflective aluminum sheets are disposed on the plural fixed tilting structures, respectively. After the light beam reflected by the document is received by the plural reflective aluminum sheets, the light beam is further reflected by the plural reflective aluminum sheets. The optical sensing module is partially disposed within the optical reflective casing and arranged along an optical path of the light beam. After the light beam is reflected by the plural reflective aluminum sheets, the light beam is received by the optical sensing module, so that a document image corresponding to the document is generated by the optical sensing module.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a conventional sheet-feeding type scanning apparatus;

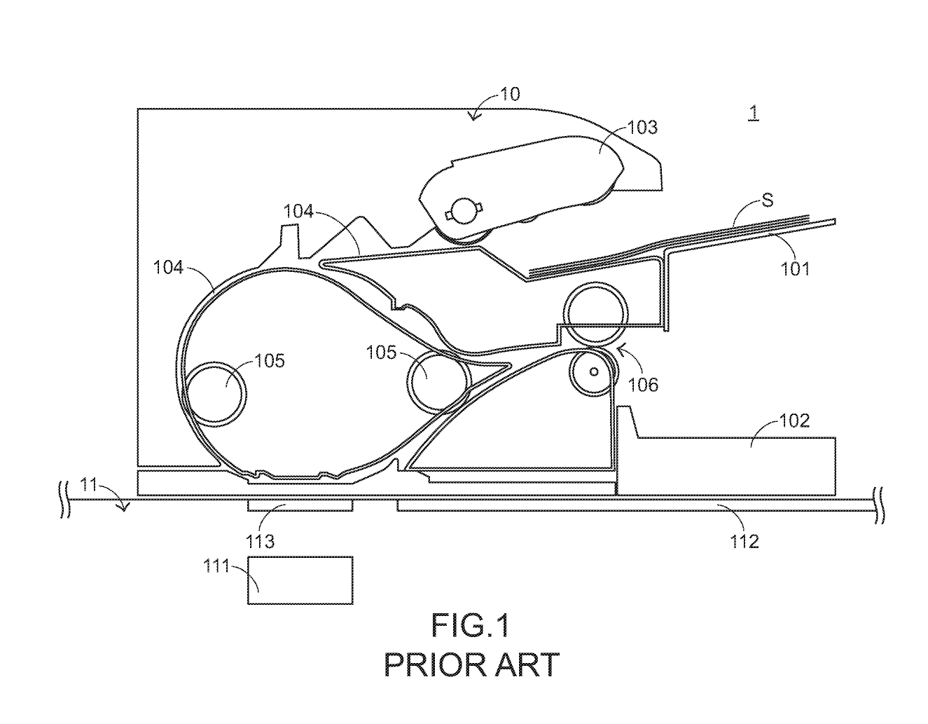

FIG. 2 is a schematic cross-sectional view illustrating a conventional scanning module structure;

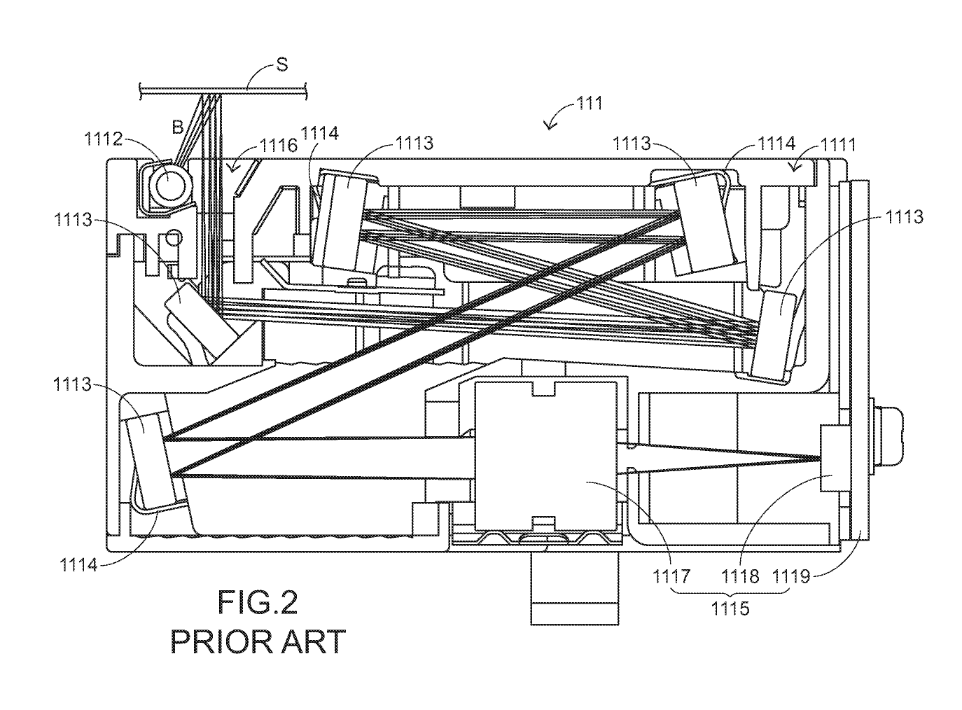

FIG. 3 is a schematic perspective view illustrating the outward appearance of a scanning module structure according to an embodiment of the present invention;

FIG. 4 is a schematic exploded side view illustrating the scanning module structure according to the embodiment of the present invention; and

FIG. 5 is a schematic side view illustrating the optical path of the scanning module structure according to the embodiment of the present invention.

### DETAILED DESCRIPTION OF THE PREFERRED EMBODIMENT

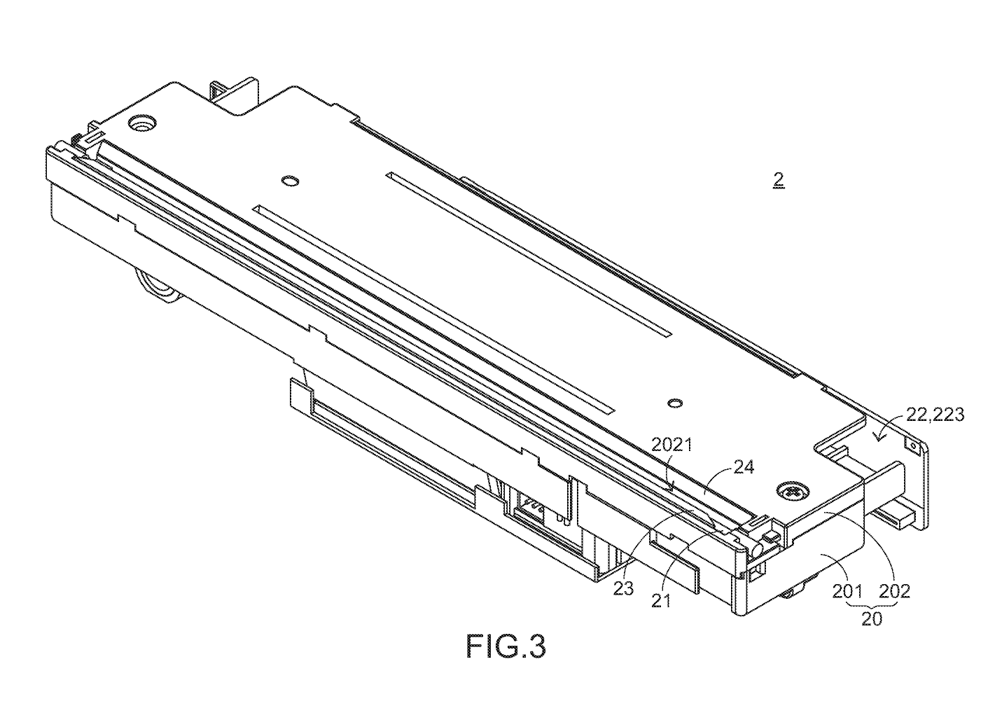

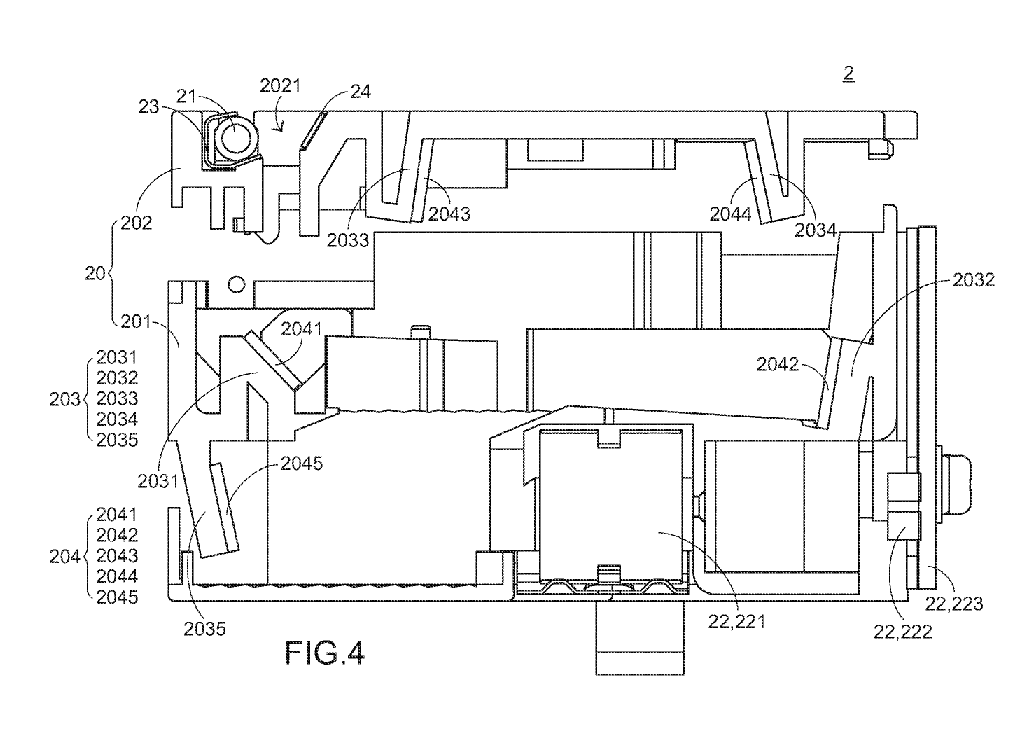

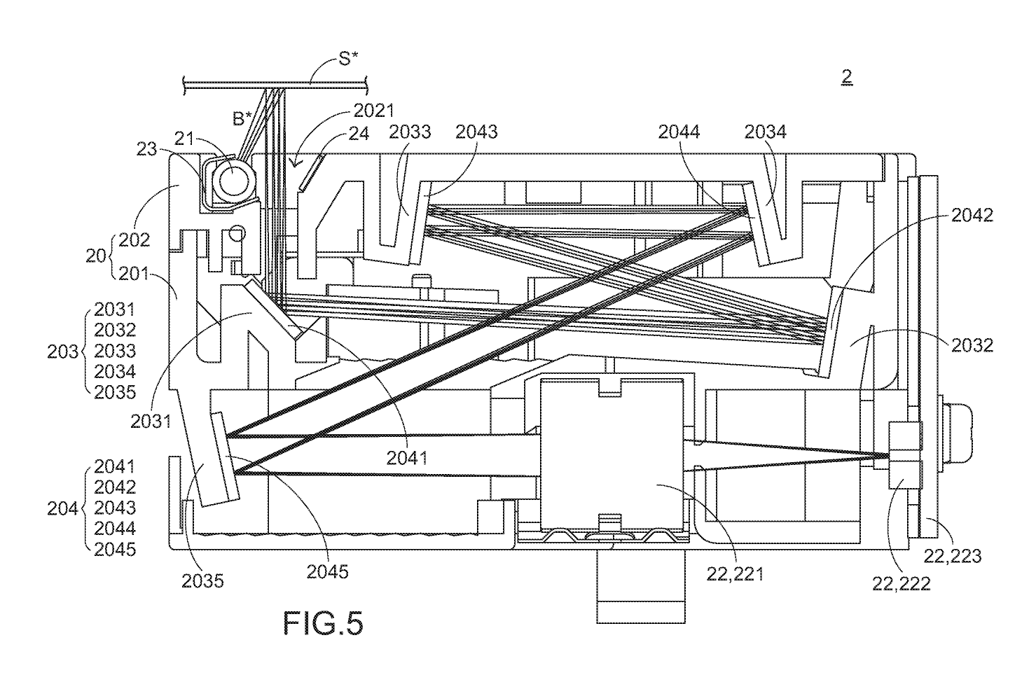

For obviating the drawbacks of the conventional scanning module structure, the present invention provides an improved scanning module structure. FIG. 3 is a schematic perspective view illustrating the outward appearance of a scanning module structure according to an embodiment of the present invention. FIG. 4 is a schematic exploded side view illustrating the scanning module structure according to the embodiment of the present invention. Please refer to FIGS. 3 and 4. The scanning module structure 2 is applied to a scanning apparatus (not shown) in order to scan a document S* (see FIG. 5). The relationships between the scanning apparatus and the scanning module structure 2 are similar to those of the prior art technology, and are not redundantly described herein.

The scanning module structure 2 comprises an optical reflective casing 20, a light-emitting element 21, an optical sensing module 22, a first reflecting structure 23, and a second reflecting structure 24. The light-emitting element 21 is disposed on the optical reflective casing 20 for emitting a light beam B* (see FIG. 5). In this embodiment, the optical reflective casing 20 comprises a main body 201, a top cover 202, plural fixed tilting structures 203, and plural reflective aluminum sheets 204. The main body 201 is covered by the top cover 202. The plural fixed tilting structures 203 are extended from an inner surface of the optical reflective casing 20. The plural reflective aluminum sheets 204 correspond to the plural fixed tilting structures 203. Moreover, the plural reflective aluminum sheets 204 are disposed on the plural fixed tilting structures 203, respectively. The optical sensing module 22 is partially disposed within the optical reflective casing 20, and arranged along an optical path of the light beam B*. The optical sensing module 22 is used for receiving the light beam B*and thereby generates a document image corresponding to the document S*. In this embodiment, the light-emitting element 21 is a lamp tube.

Please refer to FIG. 4 again. The optical sensing module 22 comprises a focusing lens 221, an optical sensing element 222, and a circuit board 223. The focusing lens 221 is disposed within the main body 201 of the optical reflective casing 20, and arranged along the optical path of the light beam B*. After the light beam B* is reflected by the plural reflective aluminum sheets 204, the light beam B* is focused by the focusing lens 221. The optical sensing element 222 is located near the focusing lens 221, and arranged at a terminal point of the optical path of the light beam B*. The optical sensing element 222 is used for receiving the focused light beam B* and thereby generates the document image. The circuit board 223 is connected with the main body 201 of the optical reflective casing 20, and the optical sensing element 222 is disposed on the circuit board 223. The circuit board 223 is used for outputting the document image. Due to the above connection relationship, the optical sensing element 222 on the circuit board 223 can be inserted into the main body 201 and arranged at the terminal point of the optical path of the light beam B* (see FIG. 4). In this embodiment, the optical sensing element 222 is a charge couple device (CCD). Alternatively, in some other embodiments, the optical sensing element may be a contact image sensor (CIS).

In the optical reflective casing 20, the plural fixed tilting structures 203 comprises a first fixed tilting structure 2031, a second fixed tilting structure 2032, a third fixed tilting structure 2033, a fourth fixed tilting structure 2034, and a fifth fixed tilting structure 2035. The first fixed tilting structure 2031, the second fixed tilting structure 2032 and the fifth fixed tilting structure 2035 are extended from an inner surface of the main body 201. Moreover, the first fixed tilting structure 2031, the second fixed tilting structure 2032 and the fifth fixed tilting structure 2035 are integrally formed with the main body 201. The third fixed tilting structure 2033 and the fourth fixed tilting structure 2034 are extended from an inner surface of the top cover 202. Moreover, the third fixed tilting structure 2033 and the fourth fixed tilting structure 2034 are integrally formed with the top cover 202. In a preferred embodiment, the plural fixed tilting structures 203 and the optical reflective casing 20 are made of a plastic material.

Please refer to FIGS. 3 and 4 again. The top cover 202 comprises an opening 2021. The opening 2021 is located at a first side of the top cover 202, and located near the light-emitting element 21. The light beam B* reflected by the document S* is transmissible through the opening 2021. In the embodiment as shown in FIG. 4, the plural reflective aluminum sheets 204 comprises a first reflective aluminum sheet 2041, a second reflective aluminum sheet 2042, a third reflective aluminum sheet 2043, a fourth reflective aluminum sheet 2044, and a fifth reflective aluminum sheet 2045. The first reflective aluminum sheet 2041 is disposed on the first fixed tilting structure 2031, and disposed under the opening 2021. After the light beam B* reflected by the document S* is transmitted through the opening 2021, the light beam B* is reflected by the first reflective aluminum sheet 2041. The second reflective aluminum sheet 2042 is disposed on the second fixed tilting structure 2032, and located at a second side of the main body 201. After the light beam B* is reflected by the first reflective aluminum sheet 2041, the light beam B* is directly reflected by the second reflective aluminum sheet 2042. The third reflective aluminum sheet 2043 is disposed on the third fixed tilting structure 2033, and located near the opening 2021. After the light beam B* is reflected by the second reflective aluminum sheet 2042, the light beam B* is directly reflected by the third reflective aluminum sheet 2043. The fourth reflective aluminum sheet 2044 is disposed on the fourth fixed tilting structure 2034, and located near the second reflective aluminum sheet 2042. After the light beam B* is reflected by the third reflective aluminum sheet 2043, the light beam B* is directly reflected by the fourth reflective aluminum sheet 2044. The fifth reflective aluminum sheet 2045 is disposed on the fifth fixed tilting structure 2035 and located near a position under the first reflective aluminum sheet 2041. After the light beam B* is reflected by the fourth reflective aluminum sheet 2044, the light beam B* is directly reflected by the fifth reflective aluminum sheet 2045.

In this embodiment, the plural reflective aluminum sheets 204 are adhered onto the corresponding fixed tilting structures 203, and the plural reflective aluminum sheets 204 are made of an aluminum metal material. For assuring that the optical path of the light beam B* is not deviated, the reflective surfaces of the plural reflective aluminum sheets 204 are in parallel with the slant surfaces of the corresponding fixed tilting structures 203. Alternatively, in some other embodiments, the plural reflective aluminum sheets are made of an aluminum alloy material.

Please refer to FIGS. 3 and 4 again. The first reflecting structure 23 is located at a first side of the opening 2021 for enclosing a part of the light-emitting element 21 and thereby confines the light beam B* which is emitted by the light-emitting element 21. Consequently, the light beam B* is controlled to be projected onto the document S*. The second reflecting structure 24 is located at a second side of the opening 2021. In case that a portion of the light beam B* is projected onto the second reflecting structure 24 across the opening 2012, the portion of the light beam B* is deflected to be projected onto the document S* by the second reflecting structure 24. In an embodiment, the first reflecting structure 23 is made of an aluminum metal material or an aluminum alloy material. Moreover, the second reflecting structure 24 is an elongated aluminum foil/PET laminate film.

Hereinafter, the operations of the scanning module structure 2 will be illustrated with reference to FIG. 5. FIG. 5 is a schematic side view illustrating the optical path of the scanning module structure according to the embodiment of the present invention. For scanning the document S*, the scanning module structure 2 is driven to be enabled. Consequently, the light-emitting element 21 emits the light beam B*. Due to the arrangement of the first reflecting structure 23, a first portion of the light beam B* is directly projected onto the document S*, and a second portion (not shown) of the light beam B* is projected onto the second reflecting structure 24. After the second portion of the light beam B* is reflected by the second reflecting structure 24, the second portion of the light beam B* is projected onto the document S*. Next, the light beam B* reflected by the document S* is propagated downwardly and transmitted through the opening 2021, and thus the light beam B* is introduced into the optical reflective casing 20. After the light beam B* is transmitted through the opening 2021, the light beam B* is reflected by the first reflective aluminum sheet 2041. Next, the light beam B* is sequentially reflected by the second reflective aluminum sheet 2042, the third reflective aluminum sheet 2043, the fourth reflective aluminum sheet 2044 and the fifth reflective aluminum sheet 2045.

After the light beam B* is reflected by the fifth reflective aluminum sheet 2045, the light beam B* is focused by the focusing lens 221. The focused light beam B* is projected onto the optical sensing element 222. After the focused light beam B* is received by the optical sensing element 222, a partial document image is generated by the optical sensing element 222. The partial document image corresponds to the portion of the document S* that is irradiated by the light beam B*. Then, as the document S* is continuously transported or the scanning module structure 2 is moved relative to the document S*, the above operations of the scanning module structure 2 are performed to acquire plural partial document images. The plural partial document images are outputted from the circuit board 223, which is electrically connected with the optical sensing element 222. Moreover, the plural partial document images are transmitted to a processing unit (not shown), which is connected with the circuit board 223. After the plural partial document images are combined by the processing unit (not shown), the document image corresponding to the document S* is generated.

It is noted that the document S* on the scanning platform is immobile when the scanning module structure is applied to a flatbed scanner. Moreover, a power mechanism is connected with the scanning module structure for moving the scanning module structure in order to scan the document S*. When the scanning module structure is applied to a sheet-feeding type scanning apparatus, the document S* is transported by an automatic document feeder of the sheet-feeding type scanning apparatus, but the scanning module structure is immobile. In case that the scanning module structure is applied to a sheet-feeding type scanning apparatus with a flatbed scanning function, the scanning module structure can scan the document S* by the above two approaches. The plural fixed tilting structures 203 of the optical reflective casing 20 are used for installing and fixing the plural reflective aluminum sheets 204. It is noted that the installation positions and angles of the plural fixed tilting structures 203 are determined according to elaborate calculation and repeat experiments. Consequently, the optical path of the light beam B* can be correctly directed to the optical sensing element 222 through the plural reflective aluminum sheets 204 and the focusing lens 221.

From the above descriptions, the present invention provides a scanning module structure. In the scanning module structure, plural reflective aluminum sheets are fixed on plural fixed tilting structures of an optical reflective casing. In addition, the plural fixed tilting structures are integrally formed with the optical reflective casing. After the optical reflective casing is produced, the plural reflective aluminum sheets are fixed on the plural fixed tilting structures, respectively. In comparison with the conventional scanning module structure of using plural fixing elements to fix plural reflective mirrors on a casing, the scanning module structure of the present invention is assembled more simply. Moreover, since it is not necessary to use additional fixing elements, the assembling cost of the scanning module structure of the present invention is reduced and the material cost of the fixing elements is saved. Moreover, since the plural fixed tilting structures are integrally formed with the optical reflective casing, even if the scanning module structure of the present invention has been used for a long time, the drawbacks of causing deformation or abrasion of the fixing elements will be avoided. In other words, since the scanning module structure of the present invention can maintain a correct optical path of the light beam, the scanning quality is stable. Moreover, since the plural reflective aluminum sheets is made of the light material (e.g. the aluminum metal material or the aluminum alloy material), the scanning module structure of the present invention is lighter than the conventional scanning module structure with the silver-based reflective mirrors. Since the scanning module structure of the present invention is lighter, the scanning module structure can be moved more easily, and flatbed scanning operation can be performed more smoothly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A scanning module structure of a scanning apparatus for scanning a document, said scanning module structure comprises:
a light-emitting element for emitting a light beam and projecting said light beam onto said document;
an optical reflective casing, wherein said light-emitting element is disposed on said optical reflective casing, and said optical reflective casing comprises plural fixed tilting structures and plural reflective aluminum sheets, wherein said plural fixed tilting structures are extended from an inner surface of said optical reflective casing, and said plural reflective aluminum sheets are disposed on said plural fixed tilting structures, respectively, wherein after said light beam reflected by said document is received by said plural reflective aluminum sheets, said light beam is further reflected by said plural reflective aluminum sheets; and
an optical sensing module partially disposed within said optical reflective casing and arranged along an optical path of said light beam, wherein after said light beam is reflected by said plural reflective aluminum sheets, said light beam is received by said optical sensing module, so that a document image corresponding to said document is generated by said optical sensing module.

2. The scanning module structure according to claim 1, wherein said optical sensing module comprises:
a focusing lens disposed within said optical reflective casing and arranged along said optical path of said light beam, wherein after said light beam is reflected by said plural reflective aluminum sheets, said light beam is focused by said focusing lens;
an optical sensing element located near said focusing lens and arranged at a terminal point of said optical path of said light beam for receiving said focused light beam and thereby generates said document image; and
a circuit board connected with said optical reflective casing for outputting said document image, wherein said optical sensing element is disposed on the circuit board.

3. The scanning module structure according to claim 2, wherein said optical sensing element is a charge couple device (CCD) or a contact image sensor (CIS).

4. The scanning module structure according to claim 2, wherein said optical reflective casing comprises:
a main body, wherein a first fixed tilting structure, a second fixed tilting structure and a fifth fixed tilting structure of said plural fixed tilting structures are extended from an inner surface of said main body, said circuit board is connected with said main body, and said optical sensing element is inserted into said main body; and
a top cover for covering said main body, wherein a third fixed tilting structure and a fourth fixed tilting structure of said plural fixed tilting structures are extended from an inner surface of said top cover, wherein said first fixed tilting structure, said second fixed tilting structure and said fifth fixed tilting structure are integrally formed with said main body, and said third fixed tilting structure and said fourth fixed tilting structure are integrally formed with said top cover.

5. The scanning module structure according to claim 4, wherein said top cover comprises an opening, and said opening is located at a first side of said top cover and located near said light-emitting element, wherein after said light beam emitted by said light-emitting element is projected onto said document, said light beam is reflected by said document and transmitted through said opening, wherein after said light beam is transmitted through said opening, said light beam is projected onto said plural reflective aluminum sheets, and said light beam is sequentially reflected by said plural reflective aluminum sheets and transmitted through said focusing lens and directed to said optical sensing element.

6. The scanning module structure according to claim 5, wherein said plural reflective aluminum sheets comprise:
a first reflective aluminum sheet disposed on said first fixed tilting structure and disposed under said opening, wherein after said light beam is transmitted through said opening, said light beam is reflected by said first reflective aluminum sheet;
a second reflective aluminum sheet disposed on said second fixed tilting structure and located at a second side of said optical reflective casing, wherein after said light beam is reflected by said first reflective aluminum sheet, said light beam is directly reflected by said second reflective aluminum sheet;
a third reflective aluminum sheet disposed on said third fixed tilting structure and located near said opening, wherein after said light beam is reflected by said second reflective aluminum sheet, said light beam is directly reflected by said third reflective aluminum sheet;
a fourth reflective aluminum sheet disposed on said fourth fixed tilting structure and located near said second reflective aluminum sheet, wherein after said light beam is reflected by said third reflective aluminum sheet, said light beam is directly reflected by said fourth reflective aluminum sheet; and
a fifth reflective aluminum sheet disposed on said fifth fixed tilting structure and located near a position under said first reflective aluminum sheet, wherein after said light beam is reflected by said fourth reflective aluminum sheet, said light beam is directly reflected by said fifth reflective aluminum sheet.

7. The scanning module structure according to claim 1, wherein said plural reflective aluminum sheets are adhered onto said fixed tilting structures, respectively, and said plural reflective aluminum sheets are made of an aluminum metal material or an aluminum alloy material.

8. The scanning module structure according to claim 5, further comprises:
a first reflecting structure located at a first side of said opening for partially enclosing said light-emitting element, wherein said light beam from said light-emitting element is confined by said first reflecting structure, so that said light beam is projected onto said document; and
a second reflecting structure located at a second side of said opening for reflecting a portion of said light beam, so that said portion of said light beam is projected onto said document.

9. The scanning module structure according to claim 8, wherein said first reflecting structure is made of an aluminum metal material or an aluminum alloy material, wherein said second reflecting structure is an elongated aluminum foil/PET laminate film.

10. The scanning module structure according to claim 1, wherein said plural fixed tilting structures and said optical reflective casing are made of a plastic material, and said the light-emitting element is a lamp tube.
